(19) United States
(12) Patent Application Publication
(10) Pub. No.: US 2010/0180748 A1
(43) Pub. Date: Jul. 22, 2010

(54) GUITAR PICK

(76) Inventor: MARK A. FREDRICK, Fitchburg, WI (US)

Correspondence Address: James Ray & Associates, 2640 Pitcairn Road, Monroeville, PA, 15146, US

(21) Appl. No.: 12/690,445

(22) Filed: Jan. 20, 2010

Related U.S. Application Data
(60) Provisional application No. 61/146,146, filed on Jan. 21, 2009.

(51) Int. Cl. G10D 3/16

(52) U.S. Cl. 84/322

(57) ABSTRACT

The present invention in several embodiments is a plectrum or pick that is used to strum or pick the strings of guitars, bass guitars, ukuleles, mandolins or other stringed instruments. This pick has apertures disposed therethrough at predetermined locations. Such apertures provide a gripping means which enables a user to grasp and control such pick. The device makes it less likely that a user will drop or lose his or her pick while playing. The apertures provide finger to thumb contact, allowing the musician to better manage the pick in their hands.

### CROSS REFERENCE TO RELATED APPLICATION

This patent application is related to and claims priority from U.S. Provisional Patent Application Ser. No. 61/146,146 filed Jan. 21, 2009.

### FIELD OF THE INVENTION

This invention generally pertains to plectrums. Specifically, the present invention relates to a guitar pick with ridges and holes to aide in grasping.

### BACKGROUND OF THE INVENTION

The invention is particularly applicable to guitar picks and will be described with particular reference thereto. However, it will be appreciated by those skilled in the art that the invention has broader applications and may also be adapted for use as a plectrum for other stringed instruments.

Picks are small tools that are easily dropped or lost. The smooth surface makes it difficult to grip the pick effectively. Other picks with holes, because of the placement of the holes, may crack prematurely. Picks with one hole tend to spin between the finger/thumb/hole, negatively affecting pick control. The current options for picks do not solve the multiple problems that musicians face. They need a pick that will not break, and that can be effectively controlled.

### SUMMARY OF THE INVENTION

The present invention in several embodiments is a plectrum or pick that is used to strum or pick the strings of guitars, bass guitars, ukuleles, mandolins or other stringed instruments. This pick has apertures disposed therethrough at predetermined locations. Such apertures provide a gripping means which enables a user to grasp and control such pick. The device makes it less likely that a user will drop or lose his or her pick while playing. The apertures provide finger to thumb contact, allowing the musician to better manage the pick in their hands.

In several embodiments the present invention comprises a ridge around each aperture to aide in griping the pick. The ridges around each hole may only protrude from one side of the pick or may protrude from both sides of the pick.

### OBJECTS OF THE INVENTION

It is, therefore, one of the primary objects of the present invention to provide an improved plectrum.

Another object of the present invention is to provide a guitar pick with holes positioned near the base of said pick.

Still another object of the present invention is to provide a guitar pick with ridge lined apertures positioned near the base of said pick.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1a is a general perspective view of the exterior of one embodiment of the present invention in which such pick member is substantially triangular and two apertures are disposed through a base of such pick member.

FIG. 1b is a partial perspective view of the invention according to one embodiment of the invention in which such pick member is substantially triangular and three apertures are disposed through a base of such pick member.

FIG. 2 is a close up top view of one embodiment of the present invention in which such pick member is substantially triangular and four apertures are disposed through a base of such pick member.

FIG. 3 is a profile view of one embodiment of the present invention in which a protruding ridge is shown.

FIG. 4 is a general perspective view of the exterior of one embodiment of the present invention in which such pick member is substantially triangular and two apertures with ridges are disposed through a base of such pick member.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

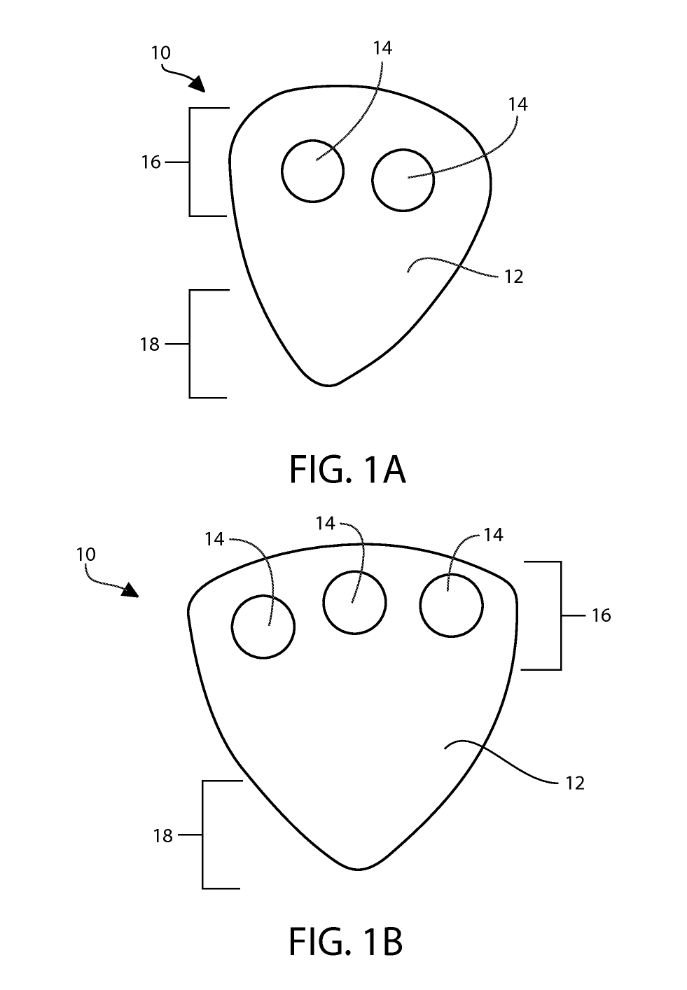

Reference is now made to FIGS. 1-4 which show several views of preferred embodiments of the present invention. The present invention is a pick device, generally designated 10 for use in strumming and picking the strings of a stringed instrument (not shown). Such device 10 includes a pick member 12 manufactured from a first predetermined material and having a first predetermined size and a first predetermined shape. Such pick member 12 includes at least one aperture 14 disposed there through at a predetermined location. Such at least one aperture 14 has a second predetermined size and a second predetermined shape. It is presently preferred that such first predetermined material is at least one of plastic, metal, and a combination thereof. It is presently preferred that such first predetermined shape is at least one of substantially triangular, substantially oval, and a combination thereof. It is presently preferred that such first predetermined shape is substantially triangular. According to one embodiment, such pick member 12 is substantially triangular and includes a base portion 16 and a tip portion 18. It is presently preferred that such predetermined location through which such at least one aperture is disposed is such base portion 16.

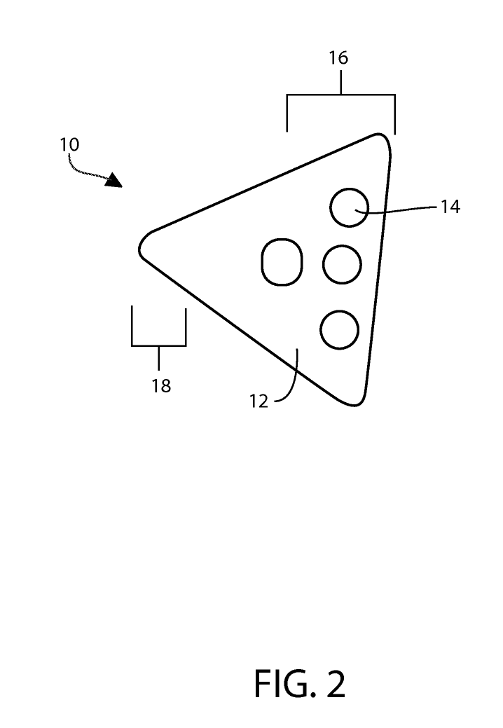

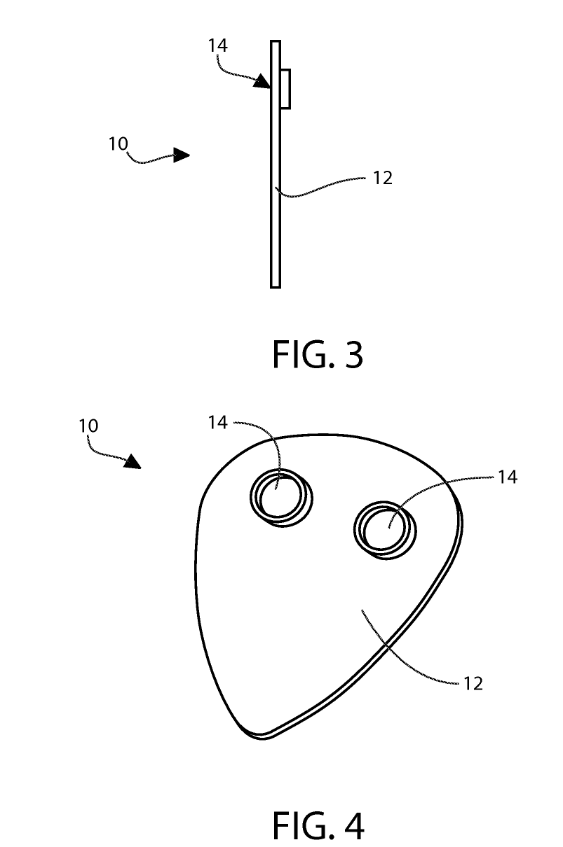

According to one embodiment such pick member 12 includes two apertures 14 disposed there through as illustrated in FIG. 1a. According to another embodiment, as illustrated in FIG. 1b such pick member 12 includes three apertures disposed there through. According to still another embodiment, such pick member 12 includes four apertures disposed there through as illustrated in FIG. 2. However, the device 10 is not meant to be limited as such and such pick member 12 may include as many apertures disposed there through as is desired by a user (not shown) and which reasonably facilitates the purpose of such device 10. It is meant that such at least one aperture will enable a user to apply skin-to-skin contact between his or her thumb and at least one fingertip such that a user has greater control of the device 10 and slippage of such pick member 12 from the grasp of such user is minimized or eliminated. According to another embodiment, such pick member 12 includes a ridge member, shown in FIG. 3 and FIG. 4, having a predetermined width and a predetermined height disposed on such pick member 12 around a perimeter of such at least one aperture. It is presently preferred that such predetermined height of such ridge member is between about ¼ millimeter and about ½ millimeter, but other height ranges could be used depending on preference or application. As shown in FIG. 3, the ridges 14 in several embodiments only protrudes on one side of said pick member 12.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A plectrum comprising:
at least one piece of resilient material,
at least two apertures formed into said at least one piece of resilient material,
wherein said at least two apertures are positioned at a base of said plectrum.

2. The plectrum of claim 1, wherein said at least one piece of resilient material is only one piece of resilient material.

3. The plectrum of claim 1, wherein said at least one piece of resilient material is substantially triangular in shape.

4. The plectrum of claim 1, further comprising at least one protrusion on at least one side of said at least one piece of resilient material.

5. The plectrum of claim 1, further comprising one ring shaped protrusion around each of said at least two apertures.

6. The plectrum of claim 1, further comprising:
at least one ring shaped protrusion formed around each of said at least two apertures,
wherein said at least one ring shaped protrusion formed around each of said at least two apertures only protrudes on one side of said at least one piece of resilient material.

7. The plectrum of claim 1, further comprising:
at least one ring shaped protrusion formed around each of said at least two apertures,
wherein said at least one ring shaped protrusion protrudes on both sides of said at least one piece of resilient material.

8. A plectrum comprising:
one piece of resilient material,
at least two apertures formed into said one piece of resilient material,
at least one ring shaped protrusion formed around each of said at least two apertures,
wherein said at least two apertures are positioned at a base of said plectrum.

9. The plectrum of claim 8 wherein: said at least one ring shaped protrusion protrudes on both sides of said at least one piece of resilient material.

10. The plectrum of claim 8 wherein: said at least one ring shaped protrusion protrudes on only one side of said at least one piece of resilient material.
